(19) United States
(12) Patent Application Publication
(10) Pub. No.: US 2025/0314601 A1
(43) Pub. Date: Oct. 9, 2025

(54) MULTIFUNCTIONAL DEVICE, SYSTEM, AND METHOD FOR MONITORING CREPED PRODUCT QUALITY AND BLADE WEAR

(71) Applicant: Buckman Laboratories International, Inc., Memphis, TN (US)

(72) Inventor: William A. Von Drasek, Oak Forest, IL (US)

(21) Appl. No.: 19/169,100

(22) Filed: Apr. 3, 2025

Related U.S. Application Data
(60) Provisional application No. 63/573,639, filed on Apr. 3, 2024.

(51) Int. Cl. G01N 21/898; B31F 1/14; G01N 21/88

(52) U.S. Cl. CPC G01N 21/898; B31F 1/145; G01N 21/8806; G01N 21/8851; G01N 2021/8874

(57) ABSTRACT

A system comprises a user computing device, e.g., smartphone, having an imaging device lens. A creping analysis module comprises a housing configured for selective coupling to the user computing device, wherein the imaging device lens is encompassed by the housing, the creping analysis module further comprising a magnifying element, a ring adapter, and a light source configured to provide a grazing angle illumination. During a calibration mode, pixels per unit length are determined from a calibration image collected via the creping analysis module at a set magnification and the grazing angle illumination via the light source. During an operating mode, crepe structure characteristics are ascertained in captured operating images comprising a tissue sheet, via the creping analysis module at the set magnification and the grazing angle illumination, and a crepe structure value is determined based on the crepe structure characteristics and the pixels per unit length.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present invention relates generally to devices, systems, and methods for use in creped product manufacturing processes. More particularly, embodiments of inventions as disclosed herein relate to a multifunctional device for use in measuring crepe structures in a manufactured sheet and/or creping doctor blade wear rates.

Conventional processes for the manufacture of creped products such as bath tissue, paper towels and napkins are well-established and require little elaboration herein. Generally stated, a continuous wet fibrous sheet is generated from a pulp stock having characteristics defined in part by the particular combination of one or more constituent fiber sources, and further in view of chemical additives, water source and the like. The paper web is transferred to a steam-heated rotary drying cylinder (an example of which is herein referred to as a “Yankee dryer”), which uses adhesive and release chemistry sprayed onto the dryer surface to provide sheet adhesion. The sheet is removed using a doctor blade that spans the width of the dryer. The doctor blade may for example be configured with a steel, ceramic, or ceramic tip, and is positioned proximate to the Yankee dryer surface. When the sheet contacts the blade, the sheet is delaminated from the dryer surface, which is referred to as the creping process.

The creping process forms macro and micro folds that break the fiber-fiber bonds that give the tissue sheet a soft feel and increase bulk. The creping process is unique to tissue manufacturing, and exemplary surface structure characteristics such as the number of crepe (folds) per unit distance (inch or cm) are related to the mechanical, operational, and chemical (MOC) of the process. Creped products can be made using (but not limited to) light dry crepe machines, wet crepe machines, as well as through air drying (TAD) and other machines that may impart a structure to the sheet prior to the Yankee dryer.

Crepe structure analysis is routinely performed to ensure that product quality meets specifications. In one conventional example, analysis can be as simple as using an ocular device and a light source to illuminate the sheet surface and manually count the crepe structures. This approach is subjective, resulting in large discrepancies from person to person. Alternatively, a lab microscope with an image capture device can be used to digitally capture an image for analysis either by manually counting the crepe structures or using an automated processing algorithm. By automating the analysis, the subjectivity is removed, but the equipment is generally restricted to lab or bench operation.

Another conventional technique is known for real-time crepe structure monitoring using an imaging device, illumination source, and a method to stabilize the moving sheet. However, this online measurement technique is expensive and requires the integration of additional systems for this purpose. As a result, there are a limited number of plants using this technique.

Offline crepe analysis systems such as Kem View™ from Kemeria and Nalco's NCAT (Nalco Crepe Analysis Toolbox) address this gap for lower-cost, portable, robust devices that standardize the analysis. However, these units require operation with a laptop for image collection and analysis. Thus, the equipment is still considered specialized requiring both the hardware and software to operate.

Another known technique for crepe analysis includes a commercial compact microscope, light source, and processing software. However, the equipment is not standardized and therefore the measurement results can be subjective, specifically regarding setup of the light source. Since the analysis requires illumination on an angle to enhance the textured surface, results can deviate by changing the light source angle. Crepe count analysis is performed by analyzing multiple areas of the image and averaging the values to get a crepe count per unit length. Data resides on a user's laptop and is not aggregated to a single database, thus combining with different data streams and/or comparing results from different sites is challenging.

Another aspect of the creping process that is important to track is the doctor blade wear rate and angle. Blade wear is typically measured using a microscope calibrated with a vernier scale to collect an image of the bald tip to measure the amount of material removed. Using the measured wear with the known service life of the blade provides the wear rate, e.g., mils/hr. The measurement may be conducted along the length of the blade to create a wear rate profile. Wear rate is impacted by conditions on the dryer and it is important to identify operating conditions with high wear rate, as this may for example indicate mechanical, operational, and/or chemical issues in addition to increased cost because of shorter blade life. Another important measurement is the crepe blade wear angle that affects the bulk and softness. Wear angle is measured offline typically using a goniometer device at discrete locations along the length of the blade.

Current processes for developing a blade wear profile include discrete measurements at a known distance along the length of the blade. The data collected may for example be stored in a spreadsheet to plot blade wear profiles along with statistics such as mean, standard deviation, etc. Measurement and data collection time for a single iteration may take between 30 and 45 minutes. As a result, analysis is not typically done on all blades but only a random selection thereof, or on blades identified when the Yankee dryer experiences operating issues.

One known example of an automated blade wear device offered by Kadant Inc. (Blade View™) operates by sliding a blade through a sensing system to measure profiles for wear rate and angle. The system is portable and provides instant feedback, reducing the measurement time. However, at least one drawback with the device is that the blade is physically handled to feed through the Blade View™ instrument. Doctor blades are sharp and require careful handling with appropriate personal protective equipment.

### BRIEF SUMMARY

In view of some or all of the aforementioned issues and objectives, systems and methods as disclosed herein may further simplify crepe analysis and address conventional issues regarding specialized hardware and software. A system as disclosed herein may utilize advancements in smartphone cameras in association with a crepe analysis module, for example combining resident image capture technology with a compact microscope adapter and grazing angle illumination to enhance the surface texture of the tissue paper. Low-cost microscope adapters that are commercially available for smartphones are not optimized for the texture imaging required for crepe structure analysis, at least because the built-in light source is designed for 360-degree illumination normal to the object.

The smartphone-compatible crepe analysis module in various embodiments as disclosed herein may be compact and comparatively low in cost compared to known systems. An exemplary system may use a point-and-click method for collecting images with processing, either done locally on the smartphone or by transmitting the image for processing in the cloud. The device's simplicity takes the burden off the user for processing and analyzing the image data, allowing them to collect more data efficiently. The image collection may comprise discrete images or a video, wherein synchronization is provided between video recording time and distance, e.g., position on the sheet or blade.

For blade profile analysis, the smartphone may be connected to a translation carriage to stabilize the image. The device may in various embodiments be dragged to a new position, wherein corresponding images are captured. In this mode, discrete images may be captured at specific positions. Alternatively, the device may be translated along the blade collecting a video or synchronized discrete image capturing at different positions along the blade. Manually collecting blade wear measurements using a microscope and imaging device may typically take 30-45 minutes for a 12 foot blade. An automated image collection and processing blade analysis time within the scope of the present disclosure may be reduced to less than 5 minutes.

Various sensors, controllers, online devices, and other intermediate components may be “Internet-of-things” (IoT) compatible, or otherwise comprise an interrelated network, wherein relevant outputs may be uploaded to a cloud-based server in real time. This data may further be made available to creped product manufacturers along with tools for, e.g., online analytical processing, graphing historical data for trends, etc. In some cases, the system may be linked to communicate with an industrial plant's local control system to improve overall diagnosis of quality issues, wherein quality data collected manually may be compared with the real time data and also compared to the monitored or determined process components such as vibration data, etc.

One particular embodiment of a system as disclosed herein comprises a user computing device comprising a first housing, a display unit on a first side of the first housing, and an imaging device lens on a second side of the first housing opposing the first side. A creping analysis module comprises a second housing configured for selective coupling to the first housing, wherein the imaging device lens is encompassed by the second housing, the creping analysis module further comprising a magnifying element, a ring adapter, and a light source configured to provide a grazing angle illumination. One or more processors are configured, during a calibration mode, to determine a number of pixels per unit length in a calibration image collected via the creping analysis module at a set magnification and the grazing angle illumination via the light source. The one or more processors are further configured, during an operating mode, to ascertain one or more crepe structure characteristics in one or more captured operating images comprising a tissue sheet, via the creping analysis module at the set magnification and the grazing angle illumination, and further to determine a crepe structure value based on the crepe structure characteristics and the determined number of pixels per unit length.

In one exemplary aspect according to the above-referenced embodiment, the crepe structure characteristics may comprise one or more peaks and corresponding valleys in the tissue sheet.

In another exemplary aspect according to the above-referenced embodiment and optional aspects thereof, the crepe structure value comprises a periodicity of the crepe structure determined via frequency spectrum analysis.

In another exemplary aspect according to the above-referenced embodiment and optional aspects thereof, the creping analysis module comprises an extension from the second housing toward the tissue sheet, wherein the one or more processors are configured during the operating mode and corresponding to movement of the user computing device along a width of the tissue sheet to determine a distance traveled using the extension as a position reference, and to capture operating images at respective predetermined distances along the width of the tissue sheet.

In another exemplary aspect according to the above-referenced embodiment and optional aspects thereof, the creping analysis module comprises a position sensor, and wherein the one or more processors are configured to synchronize outputs from the position sensor with video signals to extract images at respective distances traveled by the user computing device along a width of the tissue sheet.

In another exemplary aspect according to the above-referenced embodiment and optional aspects thereof, the system further comprises one or more sensors mounted with respect to fixed creping process elements, wherein the one or more processors are configured during the operating mode to aggregate determined crepe structure values and output signals from the one or more sensors.

In another exemplary aspect according to the above-referenced embodiment and optional aspects thereof, the one or more sensors comprise a temperature sensor configured to generate output signals representing a temperature profile of the tissue sheet, wherein the one or more processors are configured during the operating mode to aggregate determined crepe structure values and temperature profiles to the tissue sheet and determine corresponding effects thereof.

In another exemplary aspect according to the above-referenced embodiment and optional aspects thereof, the one or more sensors comprise a vibration sensor mounted with respect to a creping blade and/or dryer and configured to generate output signals representing vibration, wherein the one or more processors are configured to ascertain creping process performance, e.g., chatter conditions, mechanical vibration sources, e.g., bad oscillator bearing, crepe blade holder damage, etc., coating performance and changes in blade wear based at least in part on changes in vibration energy over time.

In another exemplary aspect according to the above-referenced embodiment and optional aspects thereof, the one or more sensors comprise a natural coating application unit sampling from the wet-end or the suction pressure roll filtrate to measure the level of suspended and dissolved solid material that impacts both the creping process and blade wear.

In another exemplary aspect according to the above-referenced embodiment and optional aspects thereof, the creping analysis module comprises an extension from the second housing toward the tissue sheet, wherein the one or more processors are configured during the operating mode and corresponding to movement of the user computing device along a length of a creping blade to determine a distance traveled using the extension as a blade edge reference, to capture operating images at respective predetermined distances along the length of the creping blade, and to determine a blade wear profile based on edge analysis from the captured images.

In another exemplary aspect according to the above-referenced embodiment and optional aspects thereof, the creping analysis module comprises a position sensor, wherein the one or more processors are configured to synchronize outputs from the position sensor with video signals to extract images at respective distances traveled by the user computing device along a length of the creping blade.

In another exemplary aspect according to the above-referenced embodiment and optional aspects thereof, the creping analysis module comprises an angle sensor configured to generate output signals representing a wear angle of the creping blade, wherein the one or more processors are further configured during the operating mode and corresponding to the movement of the user computing device along the length of a creping blade to track a determined wear angle of the creping blade with respect to the determined blade wear profile at the respective predetermined distances along the length of the creping blade.

In another exemplary aspect according to the above-referenced embodiment and optional aspects thereof, at least one of the one or more processors reside in the user computing device.

In another exemplary aspect according to the above-referenced embodiment and optional aspects thereof, at least one of the one or more processors reside in a remote server communicatively linked to the user computing device.

Numerous objects, features and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is a simplified perspective view representing an exemplary embodiment of a crepe analysis system as disclosed herein.

FIG. 2 is a perspective view representing an exemplary creping analysis module according to an embodiment as disclosed herein.

FIG. 3 is a perspective view representing the creping analysis module of FIG. 2, coupled to a user computing device.

FIG. 4 is a perspective view representing an exemplary calibration image for a 1.5 mm diameter dot.

FIG. 5 is a graphical diagram representing an exemplary line profile through the center of the dot of FIG. 4 to determine a number of pixels per 1.5 mm.

FIG. 6 is a perspective view representing an exemplary tissue sample image.

FIG. 7 is a graphical diagram representing an exemplary processed average line profile for the tissue sample image of FIG. 6.

FIG. 8 is a graphical diagram representing an exemplary array of peaks as generated using a peak detection algorithm according to a system and method of the present disclosure.

FIG. 9 is a graphical diagram representing an exemplary frequency spectrum for the line profile of FIG. 8.

FIG. 10 is a perspective view representing an exemplary cross directional crepe analysis for image collection according to an embodiment of the present disclosure.

FIG. 11 is a perspective view representing an exemplary crepe analysis scanning method according to an embodiment of the present disclosure.

FIG. 12 is a perspective view of an exemplary creping blade analysis system according to an embodiment of the present disclosure.

FIG. 13 is a perspective view representing an exemplary doctor blade wear profile scanning method according to an embodiment of the present disclosure.

### DETAILED DESCRIPTION

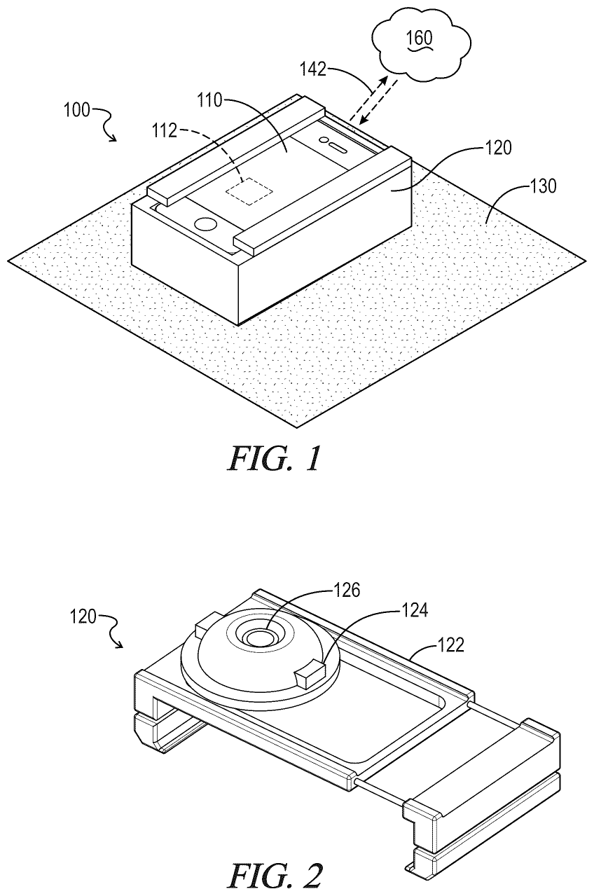

Referring generally to FIGS. 1-13, various exemplary embodiments of a system, apparatus, and/or method for analyzing creped products and/or aspects of creped product production may now be described in detail. Where the various figures may describe embodiments sharing various common elements and features with other embodiments, similar elements and features are given the same reference numerals and redundant description thereof may be omitted below.

The term “creped product” as used herein may generally refer to a fibrous sheet material, which may include additional materials. Associated fibers may be synthetic, natural or combinations thereof. The “creped product manufacturing process” as referred to herein may generally include at least the formation of an aqueous slurry comprising the associated fibers, dewatering the slurry to form a continuous fibrous sheet, applying the sheet to the Yankee dryer surface for the purpose of drying the fibrous sheet, and regulating a quantity and quality of adhesive and release aids applied to the surface of the Yankee dryer.

The term “industrial plant” as used herein may generally connote a facility for production of creped products such as, e.g., bath tissue, paper towels, napkins, and the like, independently or as part of a group of such facilities.

As represented in FIG. 1, an embodiment of a system 100 as disclosed herein may include a user computing device 110 and a creping analysis module 120 coupled together, and configured and positioned for analysis of creped product 130 such as tissue paper. The user computing device 110 may typically be a smartphone, but is not necessarily limited thereto, and may include various alternative devices having one or more processors 112, an imaging device (not shown), and appropriate connectivity features. The user computing device 110 may include a display unit (not shown), and may further preferably be communicatively linked to remote processors 160 such as for example a hosted server network 160 via a communications network 142.

In addition to conventional display functions, the display unit may include or otherwise be functionally linked to a graphical user interface (GUI) configured to enable user input, for example with respect to one or more steps or functions as described further below. The term “user interface” 128 as used herein may unless otherwise stated include any input-output module with respect to processors 112, hosted server network 160, local process controllers, or the like, for example including but not limited to: a stationary operator panel with keyed data entry, touch screen, buttons, dials, or the like; web portals, such as individual web pages or those collectively defining a hosted website; mobile device applications, etc.

The term “communications network” as used herein with respect to data communication between two or more system components or otherwise between communications network interfaces associated with two or more system components may refer to any one of, or a combination of any two or more of, telecommunications networks (whether wired, wireless, cellular or the like), a global network such as the Internet, local networks, network links, Internet Service Providers (ISP's), and intermediate communication interfaces. Any one or more conventionally recognized interface standards may be implemented therewith, including but not limited to Bluetooth, RF, Ethernet, and the like.

The hosted server 160 may be associated with a third party to the industrial plant or alternatively may be a server associated with the industrial plant or an administrator thereof. A cloud-based server implementation may be configured to process data provided from the user computing device 110, alone or further provided from other devices or controllers associated with the industrial plant.

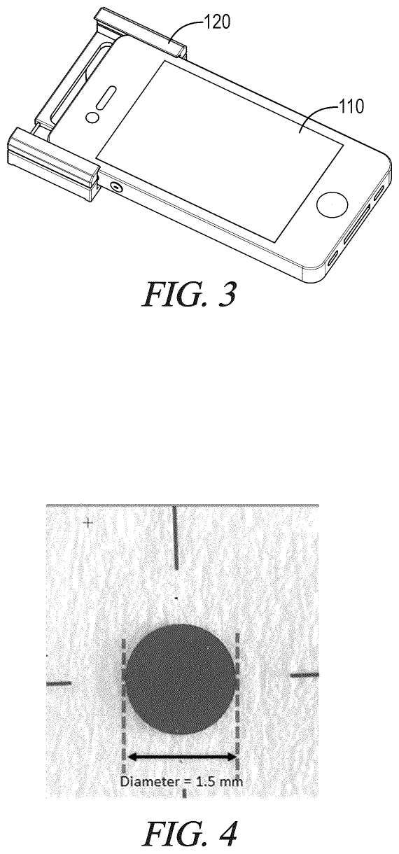

Referring next to FIGS. 2 and 3, an embodiment of the creping analysis module 120 may include a protective housing configured to detachably or otherwise selectively couple to a housing of the user computing device 110, and supporting a microscope lens 122, a modified adapter ring 124 grazing angle illumination and a light source 126 including for example light-emitting diodes (LEDs). The module 120 may further include an internal power source such as a rechargeable battery for powering the light source 126. The module 120 may further include a manual switch associated with on/off powering of the light source 126, and in some embodiments may enable selective powering of a portion of the LEDs to provide partial illumination. In some embodiments, processors or circuitry associated with the module 120 may be functionally linked to processors 112 associated with the user computing device 110, at least when appropriately coupled thereto, and enable functions such as for example control functions for the power source, light source, magnification settings of the lens, etc., via the user interface.

The creping analysis module 120 when appropriately coupled with the user computing device 110 may define a creping analysis device configured to perform steps and functions as further described herein. In some embodiments, such a creping analysis device may further be defined by an integrated unit, for example without detachable coupling of a module 120 to a conventional smartphone but rather as a dedicated device.

The above-referenced system 100 may be implemented in various embodiments of methods as further discussed below. One or more such method embodiments may be executed by processors 112 residing on the user computing device 110, and/or by remote processors 160, which may include a hosted cloud server 160, but various alternative embodiments including local or other controllers, as well as alternative and equivalent examples of software programs, algorithms, or models for analysis of a creped product or creped product manufacturing component, are contemplated within the scope of the present disclosure and the examples provided are non-limiting unless otherwise specifically noted. Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

In an embodiment of a method as disclosed herein, crepe structure analysis may be performed using a creping analysis device to perform the following steps. During a calibration mode, a calibration image may be collected, for example using a calibration slide. During an operating mode, the creping analysis device may be positioned over a creped product with the LED light source(s) arranged in the machine direction, or otherwise stated the direction in which the sheet moves on the paper machine. This may be easily identified by rotating the device 90 degrees, wherein for example if the LED light source(s) is aligned in the cross direction, the distinction between the peaks and valleys is relatively poor. When the captured image is in the correct orientation, e.g., peaks and valleys are identified, the image may be saved for processing locally on the creping analysis device or transmitted to the cloud server network for further processing.

In various embodiments, a camera zoom feature associated with the creping analysis device, for example as typically may be provided with a smartphone as the user computing device 110, allows for capturing images at higher magnifications. If the zoom feature is used, the calibration may preferably be performed at the same level. The camera settings for the creping analysis device can be preset, and may include a zoom setting, exposure, color, and format size (e.g., 4:3 vs. 6:9). With image settings preset, a calibration may typically only be required once, such that for example it may be unique for a given smartphone camera.

Crepe count analysis may be automated to reduce the two-dimensional (2D) image into a one-dimensional (1D) line profile in the machine dimension showing the peaks and valleys. A peak detection algorithm with a threshold setting may be implemented to determine a crepe structure, for example corresponding to the number of peaks. In this case, the number of peaks per unit length scale may be determined by the calibration value, e.g., pixels/mm, thereby providing the crepe count value.

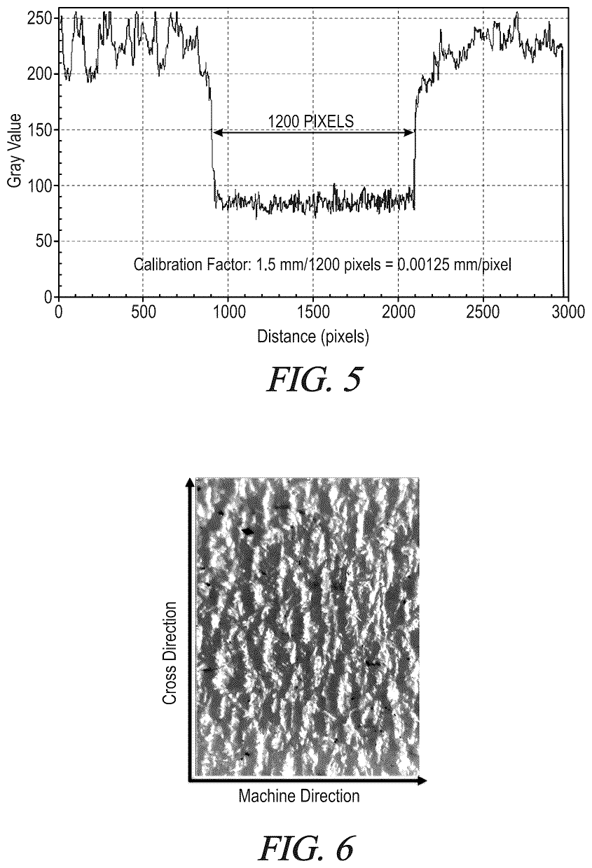

In one particular example, a calibration mode may be required or otherwise selectively enabled and a calibration image collected if the smartphone is not already calibrated, using the modified microscope adapter with grazing angle illumination at the same magnification to be used when analyzing the crepe structure. FIG. 4 illustrates an exemplary calibration image using a standard calibration slide with a 1.5 mm diameter dot. A value corresponding to pixels per unit length may be obtained from a line profile across the center of the image as shown in FIG. 5.

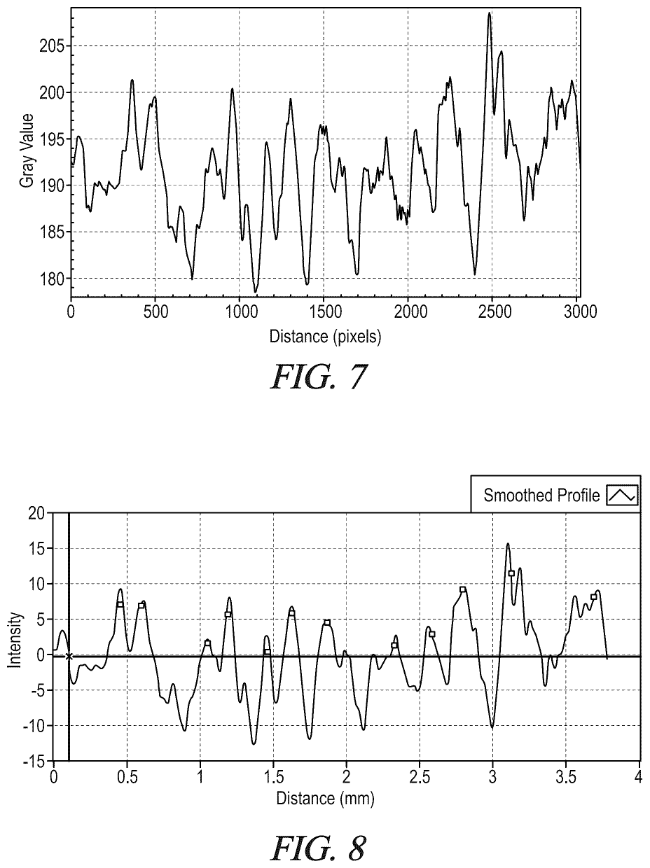

An image of the tissue paper sample may then be collected using the modified microscope adapter with grazing angle illumination at the same magnification used for the calibration. FIG. 6 shows an exemplary image collected from the tissue paper sample, whereas FIG. 7 illustrates a processed average line profile for the full cross direction.

The average line profile may be processed using a peak detection algorithm to identify characteristics of the crepe structure, for example the number of peaks per unit length. FIG. 8 represents an exemplary such analysis, with dots identifying peaks. In this case, thirteen peaks are identified across a total distance of 3.8 mm, resulting in a crepe count of 80 crepes per inch.

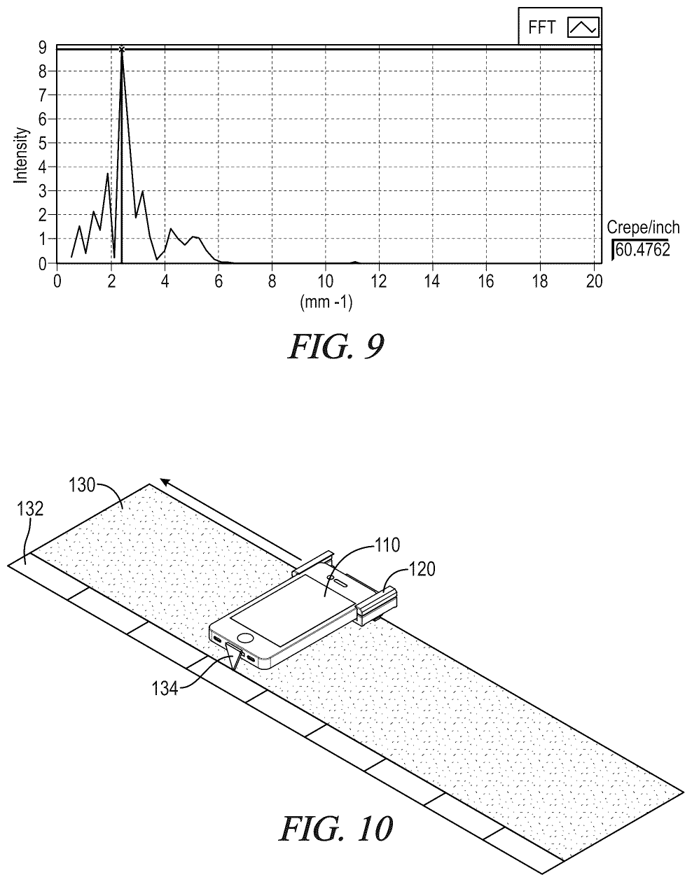

In an embodiment, the crepe structure value in addition or alternatively comprises a periodicity of the crepe structure determined via frequency spectrum analysis. For example, processing of the average line profile may be based on using fast fourier transform (FFT) to identify the major crepe frequencies. As illustrated in FIG. 9, the frequency spectrum is based on distance (mm⁻¹) for the line profile in FIG. 8. In this case, the predominant crepe frequency is 60.47 crepe/inch. Because the distance between each crepe structure varies the FFT result will not be the same as that obtained through visual peak counting. However, the FFT provides an indication of the periodicity of the crepe structure and spread in frequency indicates the randomness in crepe spacing. A decrease in the randomness may typically narrow the spread in the frequency.

In another embodiment, a creping analysis device as disclosed herein may be utilized to capture images for analysis across the whole sheet width. In this case, a section of the sheet may for example be laid out on a flat surface. The sheet width may for example be in the range of 10 to up to 20 feet. In this embodiment discrete images can be captured at known distances and then analyzed for crepe structure. FIG. 10 shows the concept with a long piece of tissue sheet 130 that can be arranged in the cross direction or machine direction. The creping analysis device includes a user computing device 110 with a creping analysis module 120 including a macro microscope, and a graduated scale 132 is arranged along the length of the sheet 130. Attached to the user computing device 110, for example supported by the housing of the creping analysis module 120, is also an indicator 134 to aid in providing a reference between the graduated scale 132 and the position of the user computing device 110. In this mode of operation discrete images may be collected at respective markings along the graduated scale 132 by translating the creping analysis device 110, 120, 134 and manually collecting an image. The creping analysis device 110, 120, 134 may for example be mounted to a moveable assembly for consistent translation along the length of the sheet 130. The image stack can then be processed locally on the user computing device 110 or sent to the cloud for processing to provide a crepe count profile for the sheet 130.

The above-referenced method embodiment may for example be applied for tissue samples arranged in either of a machine direction or cross direction, although a cross directional crepe analysis is represented in FIG. 10. Depending on whether the tissue sample is in the cross direction or machine direction, the light source may preferably be arranged perpendicular to the crepe structure.

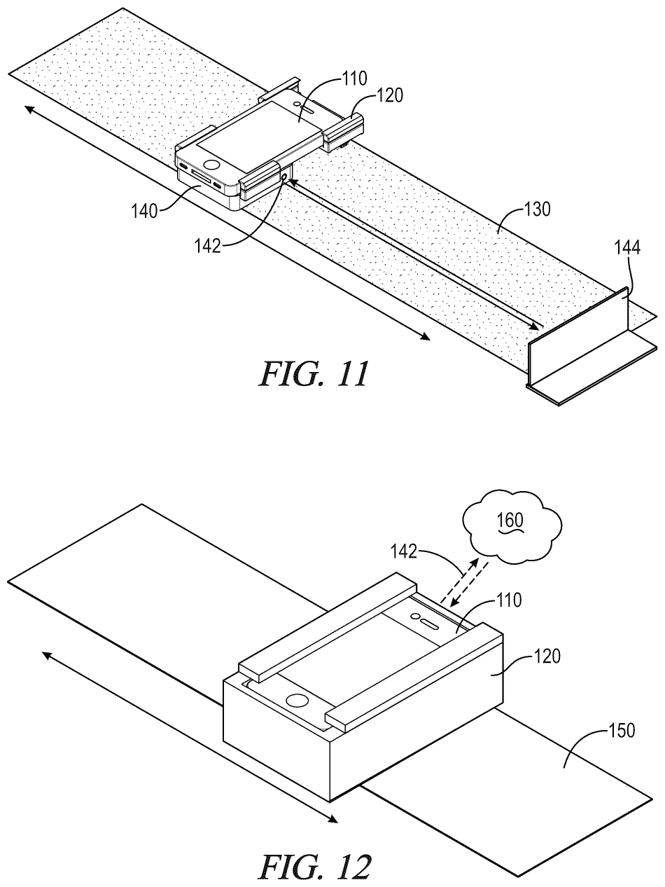

In an alternative embodiment, for example as illustrated in FIG. 11, images can be collected by taking a video and scanning the crepe analysis device (e.g., including user computing device 110 and crepe analysis module 120) across the sheet 130 using a secondary distance sensor such as a lidar sensor, ultrasonic sensor, calibrated wheel (e.g., a Hall-effect sensor mounted on a wheel that produces a pulse per revolution), etc., to track the sensor position as a function of time. The sensor position can then be synchronized with the video timing to extract an image at known distances from the video for analysis.

In the illustrated embodiment of FIG. 11, a second attachment 140 is connected to the user computing device 110, and includes a distance sensor as referenced above. The attachment 140 with distance sensor 142 may alternatively be integrated with the housing of the crepe analysis module 120. The distance measurements may for example operate on the principle of time-of-flight for light or sound wave to transmit, reflected off a target 144, and return to the sensor 142. The time for the signal to be received after transmission is converted to distance. In the case of a synchronized wheel method for tracking the distance, the target 144 may be omitted. When a scan starts, the video time and the distance time may be set to zero. Once the video recording starts, the distance timer starts, and when the scan is completed the video is stopped along with the distance timer.

An alternative mode of operation is to trigger image collection at a predetermined distance, e.g., every 6 inches. After data is collected the image quality can be evaluated to assess whether the quality meets predetermined or otherwise specified criteria, e.g., histogram standard deviation, for processing. The image quality may relate to the focus, wherein for example a normalized variance of the image may be used as a gauge for characterizing image focus.

Distance data and time data may for example be collected on the user computing device 110 using a Bluetooth connection or transmitted to the cloud server network 160 with the video or image data. Additionally, or in the alternative, output signals from the distance sensor 142 (e.g., via attachment 140) can be directly provided through the USB connector (or equivalent thereof) of the user computing device 110.

In an embodiment, a crepe analysis device as disclosed herein may be used to spot-check a roll of tissue at the end of production. Because of the compact size, the crepe analysis device can easily be placed next to the roll to capture an image and process to determine the crepe count. Furthermore, this can be used with other measurement devices, e.g., an infrared gun or an infrared camera, to measure the temperature profile of the roll after production. Identifying areas where the temperature shows a large deviation, e.g., due to a moisture streak in the coating, and using the crepe analysis device (e.g., user computing device 110 coupled with crepe analysis module 120) at the selection location to determine the effect of the temperature deviation on the crepe count. A crepe analysis device as disclosed may perform such a function in a manner that improves greatly on conventional crepe analysis tools, as direct measurements from a roll without cutting the sample cannot typically be done with such tools, or such tools are prohibitively expensive and/or clumsy in practical use.

In an embodiment, a crepe analysis device as disclosed herein, and more particularly in view of the connectivity features of the user computing device 110, e.g., cellular, wifi, or Bluetooth, may be configured to aggregate the crepe analysis data for a site with online measurement data associated with the creped product manufacturing process. Such online measurement data may be provided from one or more sensors positioned online in association with various respective components of the process, such as for example a chemical feed stage, the Yankee dryer, the creping blade, the creped product itself, a natural coating application unit, etc. Some or all of the online sensors may preferably be configured to, substantially continuously, generate signals corresponding to real-time values for conditions and/or states of the respective components. The sensors may be configured to calibrate or otherwise transform raw measurement signals into output data in a form or protocol to be processed by downstream computing devices, or in various embodiments one or more intervening computing devices may be implemented to receive raw signals from some or all of the sensors and provide any requisite calibration or transformation into a desired output data format.

The term “sensors” may include, without limitation, physical level sensors, relays, and equivalent monitoring devices as may be provided to directly measure values or variables for associated process components or elements, or to measure appropriate derivative values from which the process components or elements may be measured or calculated.

The term “online” as used herein may generally refer to the use of a device, sensor, or corresponding elements proximally located to a container, machine, or associated process elements, and generating output signals substantially in real time corresponding to the desired process elements, as distinguished from manual or automated sample collection and “offline” analysis in a laboratory or through visual observation by one or more operators.

In the context of the creping blade, one or more sensors may for example be configured to generate signals corresponding to blade vibration. In an embodiment, pulse vibration detecting units may for example use dual axis sensors to measure perpendicular and horizontal vibrations relative to the creping blade. The resulting blade vibration data can be influenced by, e.g., a configuration and/or condition of the blade, friction between the blade and the coating surface, back vibrations, mechanical characteristics of the blade/coating/Yankee dryer surface, and the like. Using the crepe analysis device (e.g., user computing device 110 coupled with crepe analysis module 120) provides a convenient way to aggregate the crepe analysis data as described above with process data such as vibration data. For example, as vibration increases from an aging blade the crepe count will decrease. In this case, processed image data may be collected along with information on the site, roll number, grade, timestamp, etc., wherein the processed crepe analysis data is then aggregated with other data streams for trending and reporting.

Monitoring behavior of the blade via vibration data from the respective sensors may, further in combination with the processed image data as described above, yield improved understanding of blade lifetime optimization and usage optimization (e.g., with respect to load, angle, run time, etc.), the different behaviors of respective blade configurations, methods for reducing friction and/or Yankee dryer edge deposits, and the like. In one embodiment, two perpendicularly mounted sensors may generate corresponding directional signals (for example, tangential force data in a first direction and perpendicular force data in a second direction), wherein a resultant value may be determined therefrom. The resultant value may be compared with a threshold value or range, such as for example a maximum value, corresponding to an intervention event wherein a change of the creping blade is recommended for maintaining quality of the creped product and/or the creped product manufacturing process more generally.

Other examples of online sensors are well known in the art for the purpose of sensing or calculating process characteristics which may be relevant to creped product quality, and exemplary such sensors are considered as being fully compatible with the scope of a system and method as disclosed herein.

Individual sensors may be separately mounted and configured, or a modular housing may be provided which includes, e.g., a plurality of sensors or sensing elements. Sensors or sensor elements may be mounted permanently or portably in a particular location respective to the creped product manufacturing process, or may be dynamically adjustable in position so as to collect data from a plurality of locations during operation.

Online sensors as disclosed herein may provide substantially continuous measurements with respect to various process components and elements, and substantially in real-time. The terms “continuous” and “real-time” as used herein do not require an explicit degree of continuity, but rather may generally describe a series of measurements corresponding to physical and technological capabilities of the sensors or imaging devices, the physical and technological capabilities of the transmission media, the physical and technological capabilities of any intervening local controller, communications device, and/or interface configured to receive the sensor output signals or images, etc. For example, measurements may be taken and provided periodically and at a rate slower than the maximum possible rate based on the relevant hardware components, or based on a communications network configuration which smooths out input values over time, and still be considered “continuous.”

Referring next to FIG. 12, an embodiment of a crepe analysis device (e.g., user computing device 110 coupled with crepe analysis module 120) as disclosed herein may be configured or otherwise further implemented to measure the wear profile of the doctor blade 150 more directly. For blade wear profiling the method is similar to crepe analysis and can be done in discrete increments or continuously. As with the embodiment previously referenced in FIG. 1, among others disclosed herein, the user computing device 110 may further preferably be communicatively linked to remote processors 160 such as for example a hosted server network 160 via a communications network 142.

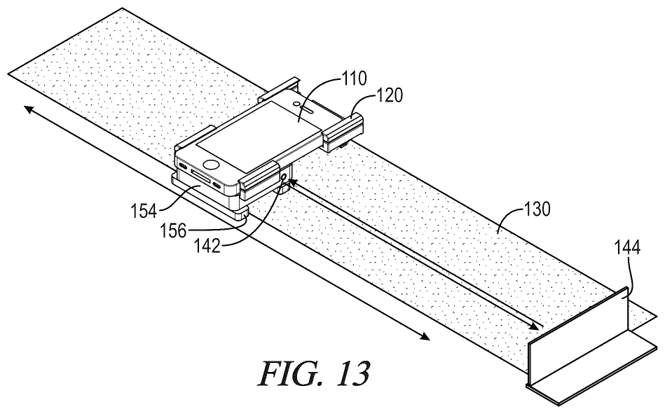

In an embodiment as further illustrated in FIG. 13, a crepe analysis device further configured for analysis of a doctor blade 150 may include elements 154, 156, 158 which act as supports and guides to reliably direct translation of the device along the edge of the blade.

In an embodiment, wear angle measurement may further be included with the blade wear measurement. Wear angle may be used to, e.g., track how the blade is wearing since the wear angle impacts the creping process. Angle measurements may be provided using an angle sensor such as a goniometer, which may be attached to the crepe analysis module 120. The angle sensor may in various embodiments be adjusted manually to obtain the angle measurements, or may be automated. An alternative method is to use multiple light sources positioned at different angles whereas the goniometer uses a single light source adjusted to different angles to determine the brightest signal (visually observed or a sensor, e.g., photodiode, camera, etc.) that corresponds to the wear angle. With the multiple light source method, the sensor unit is positioned at discrete locations along the blade. At each location the light sources are sequentially turned on and off to collect a single image for each light source when active. Processing the series of images collected from illuminating the blade edge with N light sources positioned at different angles with respect to the blade edge, consists of measuring the reflected intensity for each position, interpolating the intensity for each angle measured, and estimate the wear angle for the maximum value.

In various embodiments, outputs from a crepe analysis device as disclosed herein, including raw data and/or processed data, may be transmitted via a communications network 142 to a remote (e.g., cloud-based) server network 160. As described above, in some embodiments the outputs from the crepe analysis device may be transmitted for aggregating with online process data, which is also provided via the crepe analysis device, or which may be separately provided but aggregated using for example time stamps and other associated parameters. The remote server network may be configured for iterative development and updating of predictive models associated with tissue quality metrics, blade wear analysis, and the like. Initial models may for example be constructed based on data collected and optionally aggregated from multiple creped product manufacturing processes as may be distributed across any number of industrial locations. Once the models have been sufficiently developed, subsequent inputs from the crepe analysis device or from a given industrial plant may be processed for predictive analysis regarding quality characteristics of the creped product being produced, and/or wear state of a particular doctor blade.

In various embodiments, implementing directly monitored values from the crepe analysis device, alone or further in view of output signals from online sensors in the industrial plant, further optionally in view of models functionally linked to the cloud server network, intervention states may be indirectly predicted and/or determined for one or more quality characteristics of the creped product being manufactured. If one or more of the predicted and/or determined intervention states correspond to a determined intervention event (e.g., by comparing the quality characteristics with a received or determined quality target), methods as disclosed herein may further include the providing of feedback signals to users for actuating or triggering further manual review of the creped product, analysis or replacement of the doctor blade, automated control responses, etc.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may. As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A processor may be a graphical processing unit (GPU), or otherwise include or be associated with other specialized computing hardware for use in or in association with artificial intelligence (AI) imaging devices or for development and deployment of AI systems in accordance with the present disclosure.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A system comprising:
a user computing device comprising a first housing, a display unit on a first side of the first housing, and an imaging device lens on a second side of the first housing opposing the first side;
a creping analysis module comprising a second housing configured for selective coupling to the first housing, wherein the imaging device lens is encompassed by the second housing, the creping analysis module further comprising a magnifying element, a ring adapter, and a light source configured to provide a grazing angle illumination; and
one or more processors are configured, during a calibration mode, to determine a number of pixels per unit length in a calibration image collected via the creping analysis module at a set magnification and the grazing angle illumination via the light source;
wherein the one or more processors are configured, during an operating mode, to ascertain one or more crepe structure characteristics in one or more captured operating images comprising a tissue sheet, via the creping analysis module at the set magnification and the grazing angle illumination, and further to determine a crepe structure value based on the crepe structure characteristics and the determined number of pixels per unit length.

2. The system of claim 1, wherein the crepe structure characteristics comprise one or more peaks and corresponding valleys in the tissue sheet.

3. The system of claim 1, wherein the crepe structure value comprises a periodicity of the crepe structure determined via frequency spectrum analysis.

4. The system of claim 1, wherein the creping analysis module comprises an extension from the second housing toward the tissue sheet, wherein the one or more processors are configured during the operating mode and corresponding to movement of the user computing device along a width of the tissue sheet to determine a distance traveled using the extension as a position reference, and to capture operating images at respective predetermined distances along the width of the tissue sheet.

5. The system of claim 1, wherein the creping analysis module comprises a position sensor, and wherein the one or more processors are configured to synchronize outputs from the position sensor with video signals to extract images at respective distances traveled by the user computing device along a width of the tissue sheet.

6. The system of claim 1, further comprising one or more sensors mounted with respect to fixed creping process elements, wherein the one or more processors are configured during the operating mode to aggregate determined crepe structure values and output signals from the one or more sensors.

7. The system of claim 6, wherein the one or more sensors comprise a temperature sensor configured to generate output signals representing a temperature profile of the tissue sheet, wherein the one or more processors are configured during the operating mode to aggregate determined crepe structure values and temperature profiles to the tissue sheet and determine corresponding effects thereof.

8. The system of claim 6, wherein the one or more sensors comprise a vibration sensor mounted with respect to a creping blade and/or dryer and configured to generate output signals representing vibration, wherein the one or more processors are configured to ascertain changes in blade wear based at least in part on changes in vibration energy over time.

9. The system of claim 1, wherein the creping analysis module comprises an extension from the second housing toward the tissue sheet, wherein the one or more processors are configured during the operating mode and corresponding to movement of the user computing device along a length of a creping blade to determine a distance traveled using the extension as a blade edge reference, to capture operating images at respective predetermined distances along the length of the creping blade, and to determine a blade wear profile based on edge analysis from the captured images.

10. The system of claim 9, wherein the creping analysis module comprises a position sensor, and wherein the one or more processors are configured to synchronize outputs from the position sensor with video signals to extract images at respective distances traveled by the user computing device along a length of the creping blade.

11. The system of claim 9, wherein the creping analysis module comprises an angle sensor configured to generate output signals representing a wear angle of the creping blade, wherein the one or more processors are further configured during the operating mode and corresponding to the movement of the user computing device along the length of a creping blade to track a determined wear angle of the creping blade with respect to the determined blade wear profile at the respective predetermined distances along the length of the creping blade.

12. A method comprising:
coupling a user computing device, the user computing device comprising a first housing, a display unit on a first side of the first housing, and an imaging device lens on a second side of the first housing opposing the first side, to a creping analysis module comprising a second housing configured for selective coupling to the first housing, wherein the imaging device lens is encompassed by the second housing, the creping analysis module further comprising a magnifying element, a ring adapter, and a light source configured to provide a grazing angle illumination; and
during a calibration mode, determining a number of pixels per unit length in a calibration image collected via the creping analysis module at a set magnification and the grazing angle illumination via the light source; and
during an operating mode:
ascertaining one or more crepe structure characteristics in one or more captured operating images comprising a tissue sheet, via the creping analysis module at the set magnification and the grazing angle illumination; and
determining a crepe structure value based on the crepe structure characteristics and the determined number of pixels per unit length.

13. The method of claim 12, wherein the crepe structure characteristics comprise one or more peaks and corresponding valleys in the creped tissue sheet.

14. The method of claim 12, wherein the crepe structure value comprises a periodicity of the crepe structure determined via frequency spectrum analysis.

15. The method of claim 12, wherein the creping analysis module comprises an extension from the second housing toward the tissue sheet, the method further comprising, during the operating mode and corresponding to movement of the user computing device along a width of the tissue sheet, determining a distance traveled using the extension as a position reference and capturing operating images at respective predetermined distances along the width of the tissue sheet.

16. The method of claim 12, wherein the creping analysis module comprises a position sensor, the method further comprising synchronizing outputs from the position sensor with video signals to extract images at respective distances traveled by the user computing device along a width of the tissue sheet.

17. The method of claim 12, wherein one or more sensors are mounted with respect to fixed creping process elements and comprise a temperature sensor configured to generate output signals representing a temperature profile of the tissue sheet, and wherein the method comprises aggregating determined crepe structure values and temperature profiles to the tissue sheet and determining corresponding effects thereof.

18. The method of claim 12, wherein one or more sensors are mounted with respect to fixed creping process elements and comprise a vibration sensor mounted with respect to a creping blade and/or dryer and configured to generate output signals representing vibration energy, and wherein the method comprises ascertaining changes in blade wear based at least in part on changes in vibration energy over time.

19. The method of claim 12, wherein the creping analysis module comprises an extension from the second housing toward the tissue sheet, and wherein the method comprises, corresponding to movement of the user computing device along a length of a creping blade, determining a distance traveled using the extension as a blade edge reference, capturing operating images at respective predetermined distances along the length of the creping blade, and determining a blade wear profile based on edge analysis from the captured images.

20. The method of claim 19, wherein the creping analysis module comprises an angle sensor configured to generate output signals representing a wear angle of the creping blade, wherein the method further comprises, corresponding to the movement of the user computing device along the length of a creping blade, tracking a determined wear angle of the creping blade with respect to the determined blade wear profile at the respective predetermined distances along the length of the creping blade.
